(19) United States
(12) Patent Application Publication
(10) Pub. No.: US 2006/0187313 A1
(43) Pub. Date: Aug. 24, 2006

(54) Method and apparatus for reduced image capture delay in a digital camera

(76) Inventors: Amol S. Pandit, Greeley, CO (US); Kevin W. Allen, Fort Collins, CO (US); James Comer, Fort Collins, CO (US); Oscar A. Zuniga, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/064,404

(22) Filed: Feb. 22, 2005

(51) Int. Cl. H04N 5/228; H04N 5/232; H04N 5/235; H04N 5/222

(52) U.S. Cl. 348/222.1; 348/371; 348/362; 348/345

(57) ABSTRACT

A digital camera includes a rapid image capture mode in which a combination of automatically selected focus, exposure, aperture, and, optionally, gain settings facilitates capturing a digital image with minimal delay after the shutter button is depressed.

### FIELD OF THE INVENTION

The present invention relates generally to digital photography and more specifically to techniques for reducing image capture delay in a digital camera.

### BACKGROUND OF THE INVENTION

A persistent problem in digital photography is “shutter delay” or “shutter lag.” When the shutter button of prior-art digital cameras is pressed, the camera performs a focus and exposure adjustment cycle before it actually captures an image. This causes a delay between when the user presses the shutter button and when the digital image is captured. The result is that the moment the user desires to capture is often missed.

It is thus apparent that there is a need in the art for an improved method and apparatus for reducing image capture delay in a digital camera.

### BRIEF DESCRIPTION OF THE DRAWINGS

FIG. 1A is a functional block diagram of a digital camera in accordance with an illustrative embodiment of the invention.

FIG. 1B is a functional block diagram of an imaging module of the digital camera shown in FIG. 1A in accordance with an illustrative embodiment of the invention.

FIG. 1C is a functional diagram of a memory of the digital camera shown in FIG. 1A in accordance with an illustrative embodiment of the invention.

FIGS. 2A and 2B are a flowchart of the operation of the digital camera shown in FIG. 1A in accordance with an illustrative embodiment of the invention.

### DETAILED DESCRIPTION OF THE INVENTION

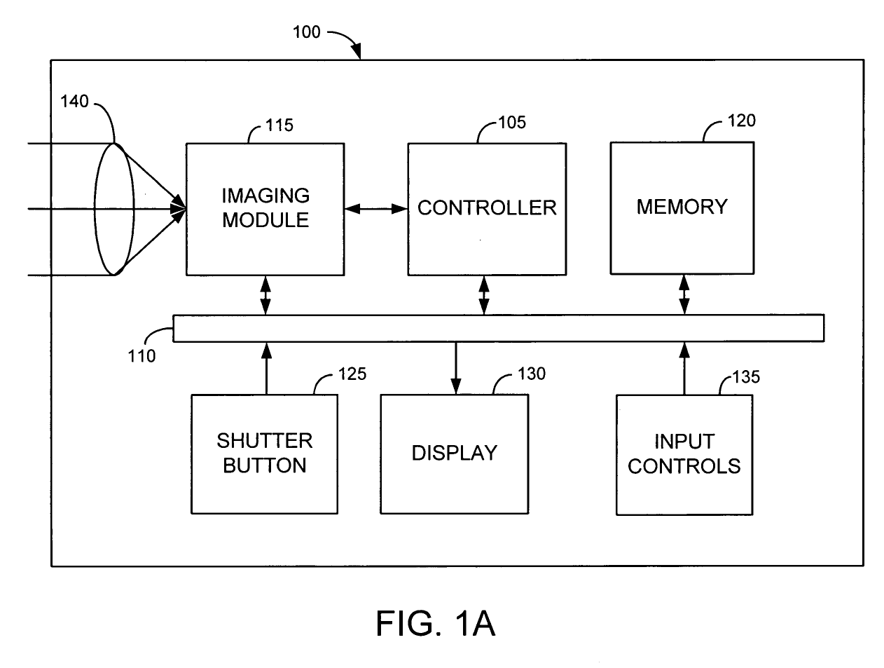

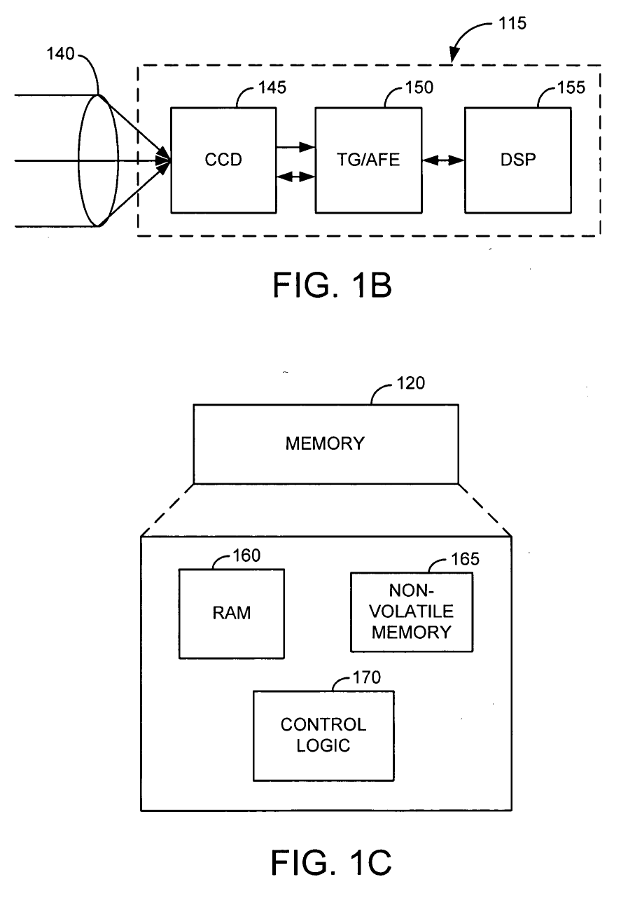

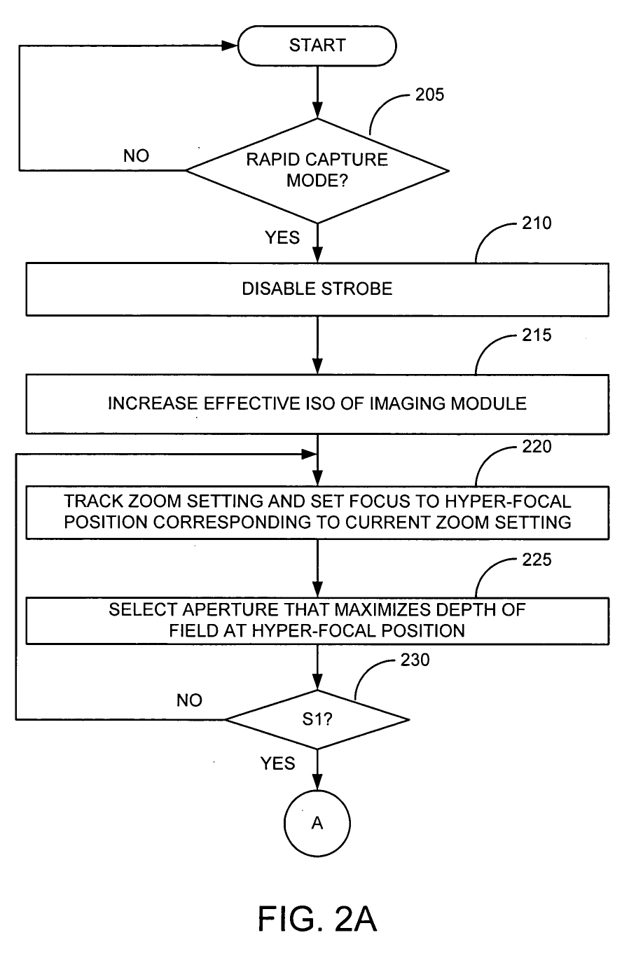

FIG. 1A is a functional block diagram of a digital camera 100 in accordance with an illustrative embodiment of the invention. In FIG. 1A, controller 105 (e.g., a microprocessor or microcontroller) may communicate over data bus 110 with imaging module 115, memory 120, shutter button 125, display 130, and input controls 135. Shutter button 125 may have three distinct positions: (1) “S0,” the position shutter button 125 nominally occupies when it has not yet been pressed; (2) “S1,” an intermediate position to which shutter button 125 may be depressed without a digital image being captured; and (3) “S2,” a position at which shutter button 125 is depressed beyond S1 and at which a digital image is captured by digital camera 100. Display 130 may be, for example, a liquid crystal display (LCD). Optical system 140 produces optical images that are converted to digital images by imaging module 115. Input controls 135 may include navigational buttons for browsing menus and captured digital images and any other input controls for controlling the operation of digital camera 100.

FIG. 1B is a functional block diagram of imaging module 115 in accordance with an illustrative embodiment of the invention. Imaging module 115 may comprise an imaging sensor array 145, a timing generator/analog front end (TG/AFE) 150, and a digital signal processor (DSP) 155. In the example of FIG. 1B, imaging sensor array 145 is shown as a charge-coupled-device (CCD) sensor array. In other embodiments, imaging sensor array 145 may be, for example, a CMOS sensor array. As indicated in FIG. 1A, imaging module 115 may, in some embodiments, communicate directly with controller 105 via DSP 155. As indicated in FIG. 1B, both data and control signals connect imaging sensor array 145 and TG/AFE 150. The sensitivity of imaging sensor array 145 and the gain at which image data is read from imaging sensor array 145 determine the effective International Organization for Standardization (ISO) rating of imaging module 115.

FIG. 1C is a functional diagram of memory 120 in accordance with an illustrative embodiment of the invention. Memory 120 may comprise random access memory (RAM) 160, non-volatile memory 165, and control logic 170. In some applications, non-volatile memory 165 may be of the removable variety (e.g., a secure digital or multi-media memory card).

When a rapid image capture mode is selected in digital camera 100, control logic 170 may cause digital camera 100 to operate in a manner that significantly reduces shutter delay in digital camera 100. How control logic 170 may significantly reduce shutter delay will be explained below. In general, the functionality of control logic 170 may be implemented in software, firmware, hardware, or any combination thereof. For example, control logic 170 may comprise a computer-readable storage medium such as a read-only memory (ROM) containing program instructions (firmware). In one embodiment, control logic 170 may comprise a flash ROM containing firmware instructions that are executed by controller 105. The firmware instructions associated with control logic 170 may be divided into a set of code segments (e.g., subroutines) that carry out specific aspects of control logic 170.

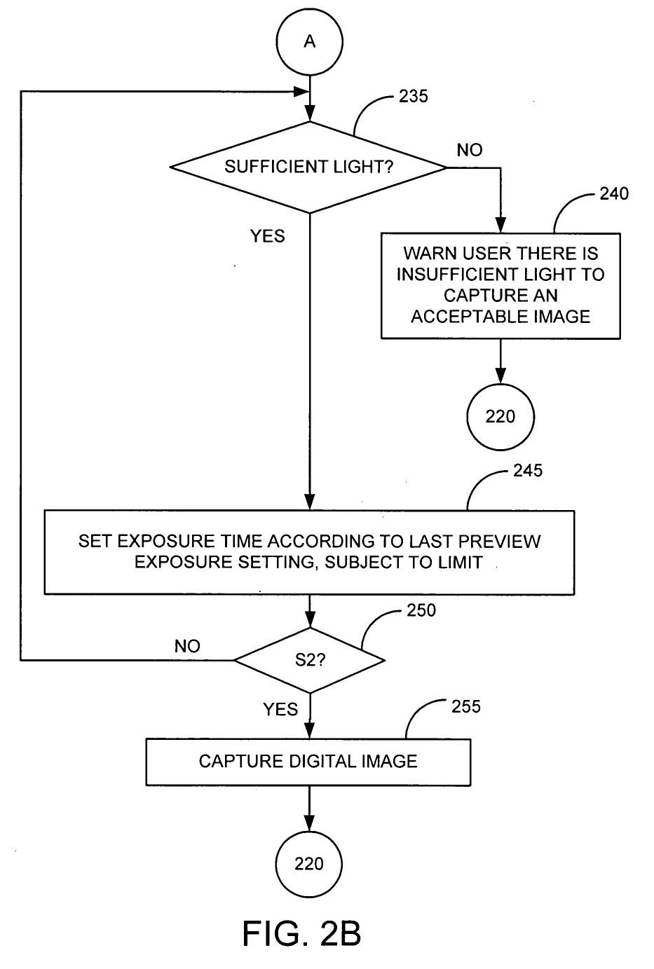

FIGS. 2A and 2B are a flowchart of the operation of digital camera 100 in accordance with an illustrative embodiment of the invention. In FIG. 2A, selection of a rapid image capture mode at 205 causes control logic 170 to perform a series of steps beginning at 210 in which a combination of settings in digital camera 100 are automatically altered to make possible the rapid capture of a high-quality digital image when shutter button 145 is depressed to the S2 position. At 210, control logic 170 may disable a strobe of digital camera 100 (not shown in FIG. 1A) to avoid any possible delay that may result from having to recharge the strobe before an image can be captured at S2.

At 215, control logic 170 may optionally increase the effective ISO rating of imaging module 115 to broaden the lighting situations in which the rapid image capture mode may be employed. For example, if imaging module 115 has a nominal effective ISO rating of 200, control logic 170 may increase the effective ISO rating to 300. Control logic 170 may increase the effective ISO rating by increasing a gain factor that is applied to image data read from imaging sensor array 145.

At 220, control logic 170 may track the zoom setting (focal length) of optical system 140 in real time and set the focus of optical system 140 to a predetermined hyper-focal position that corresponds to the current zoom setting. In the “hyper-focal position,” optical system 140 is focused at the “hyper-focal distance” corresponding to the applicable focal length (zoom setting). Focusing optical system 140 at the hyper-focal distance maximizes the depth of field in the scene. Specifically, objects from half of the hyper-focal distance to infinity will appear to be in focus in optical system 140. In one embodiment, the hyper-focal position for each possible zoom setting is stored in a lookup table that control logic 170 may consult. The contents of the lookup table may be determined uniquely for each particular optical system 140 through calibration during the manufacture of digital camera 100.

At 225, control logic 170 may select an aperture for optical system 140 that maximizes the depth of field for the selected zoom setting of optical system 140. For example, control logic 170 may have the option of choosing from among a set of apertures for a given zoom setting. To maximize depth of field, control logic 170 may select the smallest of the available apertures. In one illustrative embodiment, the aperture chosen in rapid image capture mode may range from f/4.8 to f/8. If shutter button 125 is not depressed to the S1 position at 230, the process may return to step 220. Otherwise, the process proceeds to step 235 in FIG. 2B.

At 235, control logic 170 determines whether sufficient light is present to capture an acceptable digital image. Those skilled in the digital photography art will recognize that the rapid image capture mode (small aperture, no strobe) is best suited for outdoor scenes in daylight and well-lighted indoor scenes. If control logic 170 determines that the illumination of the scene is insufficient, it may warn the user accordingly at 240 and thereafter return to 220 in FIG. 2A.

If sufficient illumination is present at 235, control logic 170 may, at 245, set the exposure time (shutter speed) for any digital image to be captured in accordance with the last exposure setting used for the “live preview mode” of digital camera 100. In live preview mode, digital camera 100 operates in a “video” mode in which reduced-resolution images are captured and displayed on display 130 multiple times per second to allow a user to compose a scene to be photographed. During live preview mode, the available illumination is metered, and exposure time (shutter speed) is adjusted to provide an acceptable exposure. Using the last exposure setting from live preview mode and setting focus to the hyper-focal distance for the current zoom setting instead of performing an additional focus and exposure update at S1 greatly reduces the delay incurred in capturing a digital image at S2. In one illustrative embodiment, control logic 170 constrains the shutter speed (exposure time) to be no longer than 1/50 of a second to avoid blurring action shots.

If shutter button 125 is depressed to S2 at 250, imaging module 115 may capture a digital image almost immediately at 255, and the process may return to 220. For example, beginning with shutter button 125 in the S0 position, a digital image may be captured in as little as 50-100 ms using the above techniques. In contrast, prior-art digital cameras may require a significant fraction of a second to capture an image, and the desired moment may easily be missed.

Though not shown in FIGS. 2A and 2B for simplicity, a user may be given an option to exit the rapid image capture mode and to select a different operating mode for digital camera 100. For example, digital camera 100 may have a knob (e.g., part of input controls 135) that selects from among a set of operating modes such as night mode, indoor mode, rapid image capture mode, and other operating modes.

The foregoing description of the present invention has been presented for the purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for reducing delay in capturing a digital image in a digital camera, comprising:
setting focus automatically to a hyper-focal position corresponding to whatever zoom setting of an optical system of the digital camera is currently selected;
selecting automatically, from a set of available aperture settings, a particular aperture setting for the optical system that maximizes depth of field at the hyper-focal position;
setting exposure time automatically in accordance with a most recent preview exposure setting, when a shutter button of the digital camera is actuated to a first position, the exposure time being constrained not to exceed a predetermined maximum exposure time; and
disabling automatically a strobe of the digital camera.

2. The method of claim 1, further comprising:
increasing automatically above a nominal value a gain factor that is applied to image data read from an imaging sensor array of the digital camera.

3. The method of claim 2, wherein the nominal value is equivalent to an ISO of 200 and the gain factor is increased to an equivalent ISO of 300.

4. The method of claim 1, wherein the method is performed in response to selection of a rapid image capture mode in the digital camera.

5. The method of claim 4, further comprising:
warning a user that there is insufficient illumination to capture the digital image in the rapid image capture mode.

6. The method of claim 1, further comprising:
capturing the digital image, when the shutter button is actuated to a second position.

7. The method of claim 1, wherein the hyper-focal position for each zoom setting of the optical system is determined through calibration and stored in a lookup table in the digital camera.

8. The method of claim 1, wherein the particular aperture setting ranges from f/4.8 to f/8.

9. The method of claim 1, wherein the predetermined maximum exposure time is 1/50 of a second.

10. A digital camera, comprising:
an optical system to produce optical images;
an imaging module to convert optical images from the optical system to digital images, the imaging module comprising an imaging sensor array;
a shutter button; and
control logic configured to carry out a method comprising:
adjusting the optical system automatically to a hyper-focal position corresponding to whatever zoom setting of the optical system is currently selected;
selecting automatically, from a set of available aperture settings, a particular aperture setting for the optical system that maximizes depth of field at the hyper-focal position;
setting exposure time automatically in accordance with a most recent preview exposure setting, when the shutter button is actuated to a first position, the exposure time being constrained not to exceed a predetermined maximum exposure time; and
disabling automatically a strobe of the digital camera.

11. The digital camera of claim 10, wherein the control logic carries out the method in response to selection of a rapid image capture mode in the digital camera.

12. The digital camera of claim 11, wherein the method further comprises warning a user that there is insufficient illumination to capture a digital image in the rapid image capture mode.

13. The digital camera of claim 10, wherein the method further comprises increasing automatically an effective ISO rating of the digital camera.

14. The digital camera of claim 13, wherein a nominal effective ISO rating of the digital camera is 200 and the effective ISO rating of the digital camera is increased to 300.

15. The digital camera of claim 10, wherein the method further comprises capturing a digital image, when the shutter button is actuated to a second position.

16. The digital camera of claim 10, wherein the hyper-focal position for each zoom setting of the optical system is determined through calibration and stored in a lookup table in the digital camera.

17. The digital camera of claim 10, wherein the particular aperture setting ranges from f/4.8 to f/8.

18. The digital camera of claim 10, wherein the predetermined maximum exposure time is 1/50 of a second.

19. A digital camera, comprising:
means for producing an optical image;
means for converting the optical image to a digital image;
means for initiating image capture; and
means for controlling image capture configured to carry out a method comprising:
setting the means for producing an optical image automatically to a hyper-focal position corresponding to whatever zoom setting of the means for producing an optical image is currently selected;
selecting automatically, from a set of available aperture settings, a particular aperture setting for the means for producing an optical image that maximizes depth of field at the hyper-focal position;
setting exposure time automatically in accordance with a most recent preview exposure setting, when the means for initiating image capture is actuated to a first position, the exposure time being constrained not to exceed a predetermined maximum exposure time; and
disabling automatically a strobe of the digital camera.

20. The digital camera of claim 19, wherein the means for controlling image capture carries out the method in response to selection of a rapid image capture mode in the digital camera.

21. The digital camera of claim 19, wherein the method further comprises increasing automatically an effective ISO rating of the digital camera.

22. A computer-readable storage medium containing program code for performing image capture with reduced delay in a digital camera, comprising:
a first code segment that automatically adjusts an optical system of the digital camera to a hyper-focal position corresponding to whatever zoom setting of the optical system is currently selected;
a second code segment that automatically selects, from a set of available aperture settings, a particular aperture setting for the optical system that maximizes depth of field at the hyper-focal position;
a third code segment that sets exposure time automatically in accordance with a most recent preview exposure setting, when a shutter button of the digital camera is actuated to a first position, the exposure time being constrained not to exceed a predetermined maximum exposure time; and
a fourth code segment that automatically disables a strobe of the digital camera.

23. The computer-readable storage medium of claim 22, further comprising:
a fifth code segment that automatically increases above a nominal value a gain factor that is applied to image data read from an imaging sensor array of the digital camera.

24. The computer-readable storage medium of claim 22, further comprising:
a fifth code segment that warns a user when there is insufficient illumination to capture a digital image.

25. The computer-readable storage medium of claim 22, further comprising:
a fifth code segment that causes a digital image to be captured, when the shutter button is actuated to a second position.

26. The computer-readable storage medium of claim 22, wherein the computer-readable storage medium comprises a read-only memory that resides in the digital camera.
